(19) United States
(12) Patent Application Publication
(10) Pub. No.: US 2026/0148417 A1
(43) Pub. Date: May 28, 2026

(54) REFLECTIVE INCLINED SURFACE AS CALIBRATION OBJECT FOR INSPECTION CAMERA ASSEMBLY

(71) Applicant: UnitX, Inc., Santa Clara, CA (US)

(72) Inventors: Killian Weber, Redwood City, CA (US); Kyle Patrick Brockichurst, Redwood City, CA (US); Martin Invaidsen, Santa Clara, CA (US)

(21) Appl. No.: 18/959,515

(22) Filed: Nov. 25, 2024

(51) Int. Cl. G06T 7/80; G01B 11/02

(52) U.S. Cl. CPC G06T 7/80; G01B 11/026; G06T 2207/30208

(57) ABSTRACT

In an example embodiment, a reflective inclined surface is used as a calibration object. During a calibration process, the relative 3D position between a light source and a camera may be determined by activating the light source and capturing an image of how the light source bounces off the reflective calibration object. This may be repeated multiple times with the reflective inclined surface turned ninety degrees, along the z-axis, each time, essentially spinning the reflective inclined surface so that the highest edge is perpendicular to where it was previously with each capture of the camera. This allows the angle at which the light source strikes the reflective inclined surface in each repetition to be calculated, and these angles can then be used to determine the 3D position of the light source relative to the camera. The same technique with the same calibration object can be used to perform camera calibration.

### TECHNICAL FIELD

This application relates generally to inspection camera assemblies. More particularly, this application relates to a reflective inclined surface as a calibration object for an inspection camera assembly.

### BACKGROUND

Inspection cameras are used in industrial products to aid in detecting defects in manufactured products. For example, if a manufacturer is producing metal castings, one or more inspection cameras may be placed in a manufacturing and/or assembly line to inspect the produced metal castings, or portions thereof, to detect any issues with quality control.

### BRIEF DESCRIPTION OF DRAWINGS

FIG. 1 illustrates a block diagram of an inspection system, according to an example embodiment.

FIG. 2 illustrates a perspective view of the underside of a light dome of the inspection system of FIG. 1, showing positioning of PCBs including light sources, such as LEDs, according an example embodiment.

FIG. 3 illustrates a layout of the LEDs of the light dome of FIG. 2, according to an example embodiment.

FIG. 4 is a diagram illustrating a first calibration object, in accordance with an example embodiment.

FIG. 5 is a diagram illustrating the turning of the first calibration object along the z-axis, in accordance with an example embodiment.

FIG. 6 is a flow diagram of an example method for calibrating the inspection system, in accordance with an example embodiment.

FIG. 7 is a diagram illustrating different light beams reflecting off calibration objects at different angles, in accordance with an example embodiment.

FIG. 8 is a block diagram illustrating a software architecture for use in the inspection system, in accordance with an example embodiment.

FIG. 9 illustrates a diagrammatic representation of a machine in the form of a computer system within which a set of instructions may be executed for causing the machine to perform any one or more of the methodologies discussed herein.

### DETAILED DESCRIPTION

When capturing images, a particular light source may not be conducive for imaging a product having a particular surface, a particular defect, and/or a particular environment. For example, surface materials or characteristics on products that affect light quality of a captured image include reflective qualities, transparent qualities, or black/opaque qualities of the product. In another example, some types of defects in the product may be difficult to detect, such as scratches or dirt. In another example, in some environments, product defects are more challenging to detect.

An inspection camera may be improved by improving the design of a lighting apparatus to increase light in various scenarios. More particularly, rather than a single light source, which provides inadequate light for capturing an image with quality sufficient to ascertain the existence of surface defects on all surface materials on various components or products, a lighting apparatus having multiple light sources may be provided. Furthermore, a controller for the lighting apparatus may be provided that allows for the multiple light sources to be independently controlled, allowing for lighting combinations and sequences to be utilized to maximize the flexibility of the lighting apparatus to provide sufficient light suited to a number of different products, components, materials, and environments.

In such environments, a camera is used to capture images of the manufactured products. This camera, however, may be positioned separately from the light sources themselves. For example, the camera may be located on a separately adjustable apparatus from the lighting sources.

An issue that arises is that in order to properly analyze images of manufactured products, the relative 3D position(s) between the camera and any light sources used to light the manufactured products must be known. Determining the relative 3D position(s) may be performed during a calibration process, using a calibration object which is placed in the field of view of the camera while one or more light sources are activated, allowing the system to be calibrated.

In an example embodiment, a reflective inclined surface is used as a calibration object. During a calibration process, the relative 3D position between a light source and a camera may be determined by activating the light source and capturing an image of how light from the light source bounces off the reflective inclined surface. In an example embodiment, this may be repeated multiple times with the reflective inclined surface turned (e.g., through ninety degrees) along the z-axis, each time essentially turning the reflective inclined surface so that the highest edge is perpendicular to where it was previously with each capture of the camera. Thus, the light sources are seen in the reflective surface at different orientations. This allows the angle at which the light source strikes the reflective inclined surface in each repetition to be calculated, and these angles can then be used to determine the relative position, in three dimensions, of the light source relative to the camera. With the intelligent use of calibration object one can use the same dataset to calibrate both camera and light sources.

### Example Inspections System

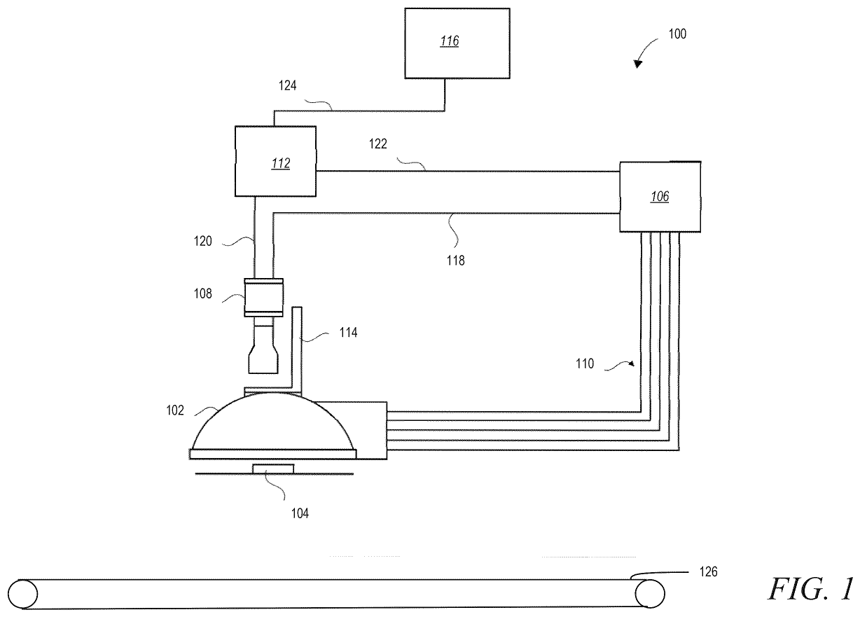

FIG. 1 illustrates a block diagram of an inspection system 100, according to an example embodiment. The inspection system 100 includes a light dome 102, a camera 108, a controller 106, an industrial computer 112, and a factory computer 116. The factory computer 116 is in communication with the controller 106 and the computer 112 via a wired or wireless factory network 124.

The light dome 102 in use illuminates a target object 104, such as a metal casting or other product that is to be inspected for defects. The light dome 102 includes a housing containing a number of light sources as will be described in more detail below. In some examples, the light sources comprise a plurality of LEDs or display screens arranged to provide flexibility in illuminating the target object 104. The light sources are selectively activated by the controller 106 using power cables 110. A light source is a unit of lighting that is individually addressable by the controller 106 to illuminate the target object 104. An individual light source may thus comprise a single LED or a number of LEDs that are addressable as a group. A light source may also form part of a subset of a light generating unit, such as a group or block of pixels in a flexible display screen. In an example embodiment, the light dome 102 includes at least ten individually addressable light sources arranged within the light dome 102, to provide lighting flexibility.

The camera 108, which may be mounted to the light dome 102 by a bracket 114, captures images of the illuminated target object 104 through a hole in the top of the light dome 102. The camera 108 is triggered by the controller 106 via a trigger line 118, synchronized to the actuation of the light sources in the light dome 102.

The controller 106 controls operation of the camera 108 and illumination of the target object 104 by the light dome 102. The controller 106 receives instructions from the computer 112 via a control line 122. The controller 106 may be implemented by a hardware processor disposed in the camera 108. The controller 106 may further include hardware components that may include a combination of Central Processing Units (“CPUs”), buses, volatile and non-volatile memory devices, storage units, non-transitory computer-readable media, data processors, processing devices, control devices transmitters, receivers, antennas, transceivers, input devices, output devices, network interface devices, and other types of components that are apparent to those skilled in the art. These hardware components within the user device may be used to execute the various applications, methods, or algorithms disclosed herein independent of other devices disclosed herein.

The controller 106 illuminates the target object according to one or more optimal lighting configurations. The lighting configurations may be defined as a matrix, where each value of the lighting configuration matrix represents a working status of each independently controllable light source, such as one or more LEDs and/or groups of pixels on a flexible display screen. The matrix may also include brightness or color values for particular configurations. The lighting configurations may also be arranged into a configuration sequence, which specifies an order of lighting configurations to be executed for a particular target object 104, such that a number of images under different lighting conditions are captured by the camera 108.

The computer 112 runs software that provides a user interface that can be used to specify lighting configurations and sequences, which can be loaded into the controller 106. The computer 112 also instructs operation of the controller 106 via the control line 122, and receives images captured by the camera 108 via a data line 120.

The factory computer 116 provides overall factory control and can receive operational data and captured images, which were taken by the camera 108, from the controller 106 and the computer 112 via the factory network 124. The factory computer 116 can also provide instructions to control or initiate operation of the inspection system 100, based for example on other factory operations such as the movement of target objects 104 past the light dome 102.

An object that is being examined for defects may be placed on a conveyor belt 126 and the conveyor belt 126 may move, causing the object to move so that it is at least somewhat under the camera 108 while one or more light sources on the light dome 102 are illuminated. As mentioned before, this may be performed under fly capture conditions, where the conveyor belt 126 does not stop and thus where the object does not stop under the camera 108. Instead, multiple images of the object are captured at different times under different light conditions. Therefore, different angles of the object can be taken but instead of the camera 108 moving around the object to capture these different angles the object moves while the camera 108 stays fixed, although it is not mandatory that this be performed under fly capture conditions.

As mentioned earlier, a calibration operation is first performed in order to achieve image alignment when multiple images of an actual part are performed for defect detection. During this calibration, a calibration object is placed under the camera 108 at various different orientations to calibrate the inspection system.

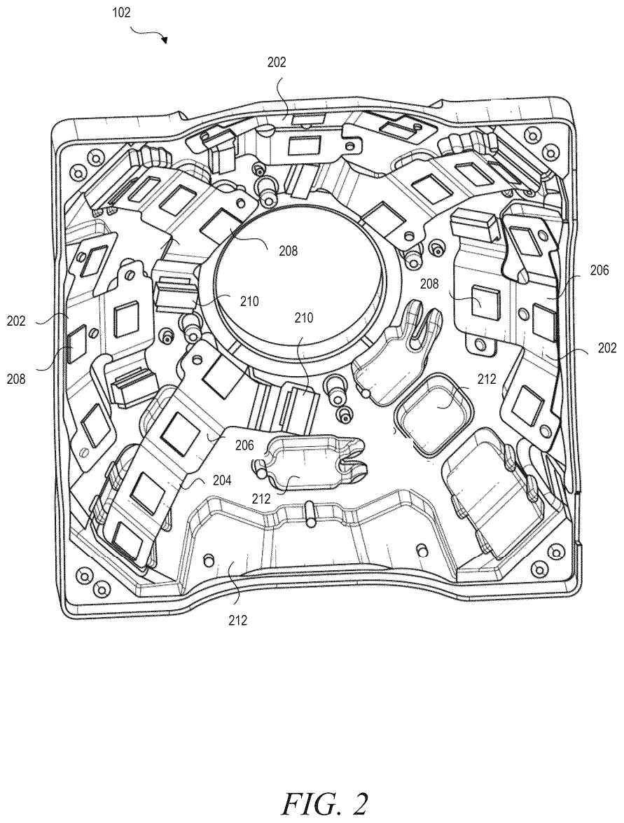

FIG. 2 illustrates a perspective view of the underside of the light dome 102 of the inspection system of FIG. 1, showing the positioning of PCBs including light sources, such as LEDs, according to some examples. In this view, some of the PCBs have been removed to show the detail of the underside of an outer cover in addition to the positioning of the LEDs.

The underside of the light dome 102 is generally hemispherical in shape and includes four T-shaped PCBs 202 and four L-shaped PCBs 204, according to some examples. In this view, the L-shaped PCB 204 on the lower left side is not shown, and the T-shaped PCB 202 on the left side is not shown.

Each PCB 202,204 includes a substrate 206, a connector 210 and a number of high-powered LEDs 208 for providing selective illumination of the target object 104 under control of the controller 106. As can be seen from the figure, the underside of the outer cover includes a number of islands or pads 212, which define raised surfaces on the underside of the outer cover for supporting each of the T-shaped PCBs 202 and the L-shaped PCBs 204. The locations of the pads 212 correspond to the locations of the LEDs 208, and thermal paste is provided between each pad 212 and the LEDs 208 to facilitate heat transfer from the LEDs to the light dome 102.

While not pictured, a camera may be located in the center of the light dome 102. Notably, this camera may not be physically attached to the light dome 102 and thus there is uncertainty about the distances between the camera and the LEDs 208 on the light dome 102. In addition to variance in distances in the x-and y-axes, there could also be variance along the z-axis as well, since it is possible that the light dome 102 may not be oriented completely parallel to the ground (or base at which the camera is pointed) and thus some of the LEDs 208 could actually be oriented higher than others.

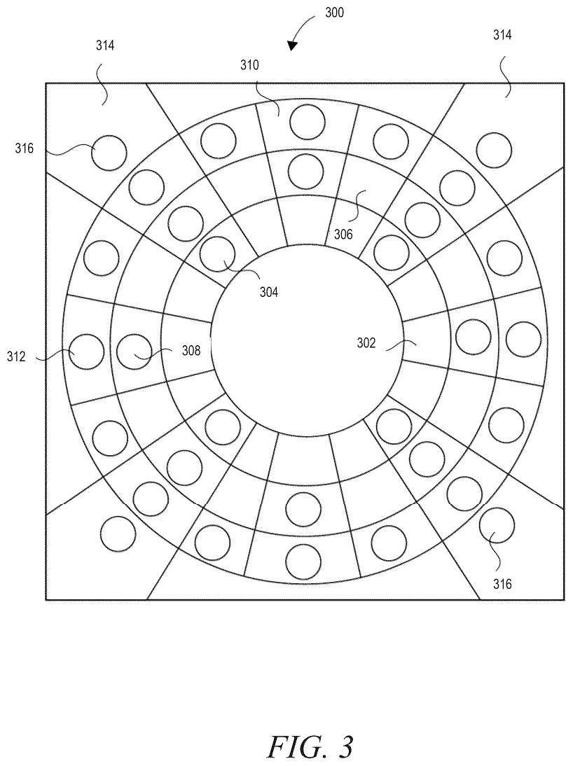

FIG. 3 illustrates the layout 300 of the LEDs 208 of the light dome 102 of FIG. 2, according to an example embodiment. The LEDs 208 are symmetrically arranged as four inner ring LEDs 304 in an inner ring 302, eight middle ring LEDs 308 in a middle ring 306, and sixteen outer ring LEDs 312 in an outer ring 310. To provide additional light coverage, four corner LEDs 316 are located at corner positions 314.

### Example Calibration Of Inspection System

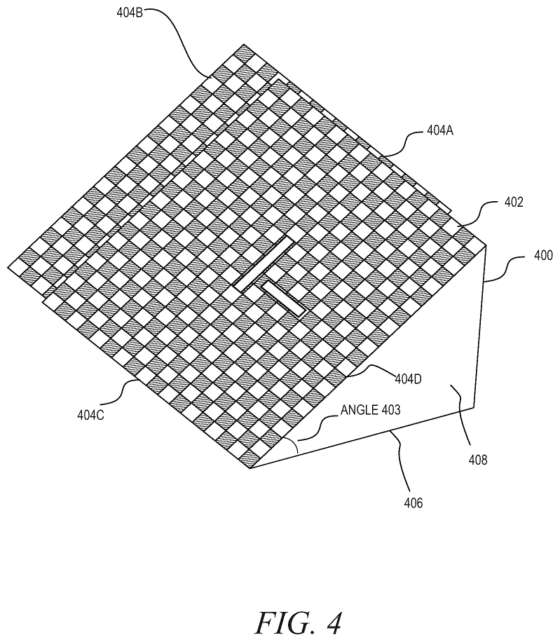

FIG. 4 is a diagram illustrating a first calibration object 400, in accordance with an example embodiment. Here, a first calibration object 400 includes a reflective inclined surface 402. The reflective inclined surface 402 may include, for example, a checkerboard pattern, and may be made of any reflective material, such as opal glass. Since it is reflective, it acts to reflect light from one or more light sources such as the LEDs 304, 308, and 312.

Here, the reflective inclined surface 402 has four perpendicular edges including 404A, 404B, 404C, and 404D, like a square or a rectangle. The term “inclined surface” is intended to convey that this surface lies at an angle relative to the bottom 406 of the first calibration object 400. Here, for example, the angle is five degrees, although other angles are possible. Indeed, as will be discussed in more detail below, there may be multiple calibration objects with different angles. This angle means that one of the edges of the reflective inclined surface 402, specifically edge 404A, is parallel to the bottom 406 of the first calibration object 400 and also at the highest point relative to the bottom 406. By contrast, edge 404C is also parallel to the bottom 406 but is at the lowest point relative to the bottom 406. Edges 404B and 404D are not parallel to the bottom 406, but rather are inclined at the angle 403 of the reflective inclined surface 402 (e.g., five degrees).

It should also be noted that while the reflective inclined surface 402 is a reflective surface, the other surfaces on the first calibration object do not need to be reflective. In this diagram, for example, surface 408 does not need to be reflective.

As mentioned earlier, the first calibration object 400 is placed on the under the camera of FIG. 1 in a first orientation with respect to the z axis, and then one or more images is taken. The first calibration object 400 is then turned approximately ninety degrees along the z-axis and the process is repeated. This turning and repeating is itself repeated until images of the first calibration object 400 in all four positions are obtained.

It should be noted that FIG. 4 depicts the first calibration object 400 as a single molded object containing the reflective inclined surface 402 and the sides 408 and bottom 406. However, it is not necessary to have the pieces all molded together. For example, the reflective inclined surface 402 may be a different component than the sides 408 and bottom 406, with the sides 408 and bottom 406 acting as a holder that temporarily holds the reflective inclined surface 402 at the angle 403. The reflective inclined surface 402 could then be removed from this holder and placed in a different holder that holds the reflective inclined surface 402 at a different angle. The reflective inclined surface 402 could also be placed flat under the camera without any holder, making it not inclined. These embodiments will be discussed in more detail later.

It should also be noted that while this disclosure provides many examples of inclined flat surfaces being used as or in calibration objects, it is not necessary that the calibration objects always have an inclined flat surface. The surface could potentially be flat but not inclined, or the surface could be inclined but not flat. Indeed, in some example embodiments, the surface need not be either inclined nor flat. In such instances, however, the ability to detect the orientation of the pattern on the surface becomes even more important.

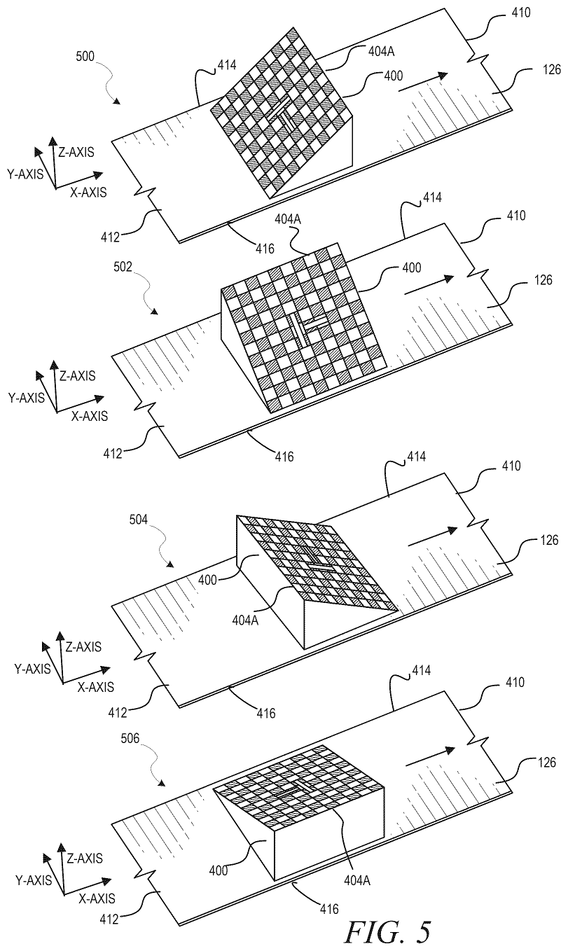

FIG. 5 is a diagram illustrating the turning of the first calibration object 400 along the z-axis in accordance with an example embodiment. The calibration object may be placed under the camera 108 of FIG. 1 to calibrate the camera 108 of the inspection system 100. Here, the conveyer belt 126 is depicted with an arrow indicating the direction in which the conveyor belt 126 would ordinarily move when carrying a product to be inspected for defects. For ease of discussion, the direction in which the arrow is indicating is considered the “front” 410 of the conveyor belt 126, wherein the direction opposite the direction in which the arrow is indicating is considered the “rear” 412 of the conveyor belt. As can be seen, in a first view 500, the first calibration object 400 has a first orientation, where edge 404A is closest to the front 410 of the conveyor belt 126. In a second view 502, the first calibration object 400 has been turned clockwise ninety degrees so that edge 404A is now closest to one side 414 of the conveyor belt 126. In a third view 504, the first calibration object 400 has been turned clockwise another ninety degrees so that the edge 404A is now closest to the rear of the conveyor belt 126. In a fourth view 506, the first calibration object 400 has been turned clockwise another ninety degrees so that the edge 404A is now closest to the other side 416 of the conveyor belt 126.

As mentioned earlier, in each orientation, one or more images of the first calibration object 400 may be taken. If there are multiple images taken at any or all of those orientations, they may be taken under differing lighting conditions. For example, different ones of the independently controllable LEDs 208 may be activated for each of the images taken of the first calibration object 400 in each configuration.

Thus, for example, four different lighting configurations may be used to take four different images of the first calibration object 400 when it is in each of the four orientations, resulting in sixteen different images taken of the first calibration object 400.

Additionally, in an example embodiment, this process may be repeated with multiple different calibration objects. For example, in addition to the process described above with respect to the first calibration object 400, a similar process can be performed using a second calibration object having a different incline angle. Additionally, in some example embodiments, a third calibration object having no incline angle may be used as well. It should be noted that when the calibration object has no incline angle, there is no need to rotate the calibration object into multiple orientations since each orientation will be identical. As such, rather than taking the one or more images in each of the four configurations, for such a flat calibration object the one or more images are just taken in the single configuration. In this example embodiment, a combination of the first, the second, and the third calibration objects described above can all be used. The result then, in the case where four different lighting configurations are used for each orientation, sixteen images taken of the first calibration object, sixteen images taken of the second calibration object, and four images taken of the third calibration object (which is flat).

As mentioned before, it is not necessary that the second calibration object be a single molded object and can instead comprise a combination of a reflective surface and a holder that temporarily holds the reflective surface at the desired angle.

The different lighting configurations and calibration object orientation cause different light reflections in each image.

Knowing the position and orientation of the reflective surface and the 2-dimensional pixel positions of the light source, the calibrated camera can be used to calculate the 3-dimensional point of the reflection and the angle towards the light source at this point. Multiple orientations of the calibration object thus gives multiple paths to the same light source and triangulation can be performed.

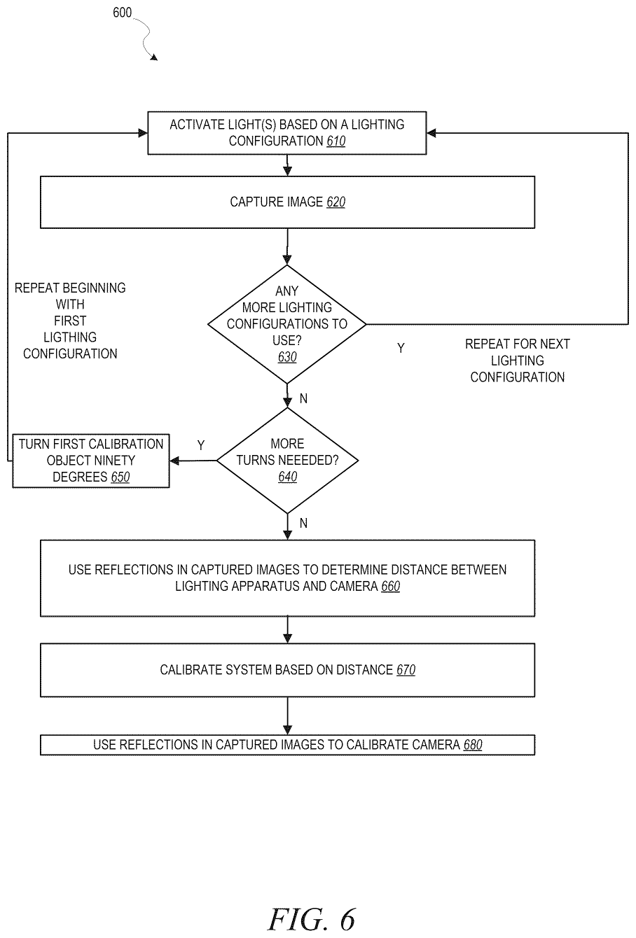

FIG. 6 is a flow diagram of an example method 600 for calibrating an inspection system, in accordance with an example embodiment. The method 600 may be used to calibrate the example inspection system 100 and, according, is described by way of example with reference thereto. The method 600 utilizes a first calibration object (e.g., calibration object 400) comprising a first flat surface (e.g., inclined surface 402 at an incline of a first angle from a second surface (e.g., bottom 406), the first flat surface being reflective, the second surface being perpendicular to a z-axis of the first calibration object.

At operation 610, in response to a first calibration object being present in front of a camera 108 such that the camera 108 is facing a first flat surface of the first calibration object, one or more lights (e.g. LEDs 208) of a plurality of independently controllable light sources on a lighting apparatus (e.g., light dome 102) is activated based on a lighting configuration to direct light onto the first flat surface. At operation 620, the camera 108 is used to capture one or more images of one or more reflections of the light on the first flat surface.

At operation 630, it is determined if there are any more lighting configurations to use. If so, then the method 600 loops back to operation 610 for the next lighting configuration. If not, then at operation 640, it is determined whether any more turns of the calibration object need to be performed. In an example embodiment, this just means it is determined if the calibration object has been turned three times, since each turn is 90 degrees and thus three turns means that the object will have been placed at 0 degrees, 90 degrees, 180 degrees, and 270 degrees, thus completing one full orbit around the z-axis. If each turn constitutes something other than 90 degrees, than completing a full orbit may mean more or fewer turns. If it is determined that more turns are needed, then at operation 650, the first calibration object is turned ninety degrees and the method 600 loops back to operation 610 with the first lighting configuration. If it is determined that no more turns are needed, then at operation 660 reflections in the captured images are used to determine distance between the lighting apparatus and the camera. Then, at operation 670, the system is calibrated based on the distance. Then, at operation 680, the reflections are also used to calibrate the camera.

Camera calibration may use x number of orientations of a known calibration pattern (e.g., checkerboard) at a known orientation. 9 images may be taken and in each the pattern can be detected and used to calibrate the camera. This also computes the orientation and position of the pattern relative to the camera. The light source(s) can then be detected in the reflective surface and used to calibrate the light source(s).

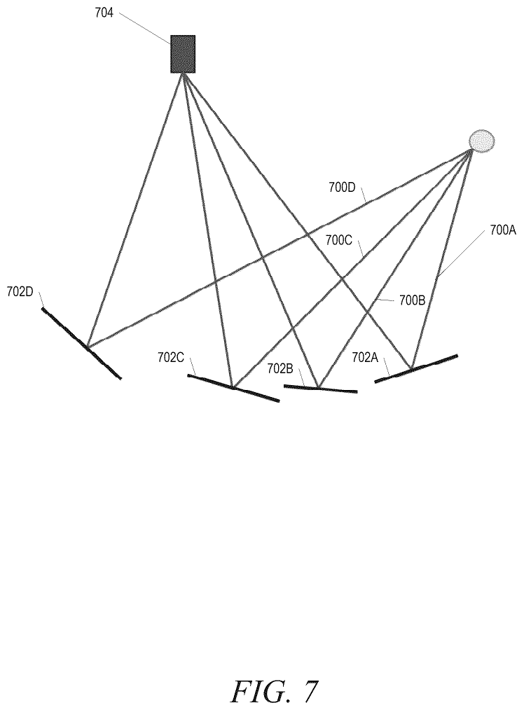

FIG. 7 is a diagram illustrating light beams 700A, 700B, 700C, 700D reflecting off calibration objects 702A, 702B, 702C, 702D of different angles, in accordance with an example embodiment. Here, camera 704 takes pictures, including the light beams 700A, 700B, 700C, 700D and calibration objects 702A, 702B, 702C, 702D and then these pictures can be used to calibrate the system as described earlier. Notably, it is not necessary that the calibration objects 702A, 702B, 702C, 702D be any particular shape or configuration, as long as the different angles are captured.

In view of the disclosure above, various examples are set forth below. It should be noted that one or more features of an example, taken in isolation or combination, should be considered within the disclosure of this application.

Example 1 is a system comprising a lighting apparatus including a plurality of independently controllable light sources: a camera; a first calibration object comprising a first flat surface at an incline of a first angle from a second surface, the first flat surface being reflective, the second surface being perpendicular to a z-axis of the first calibration object; a computer system comprising at least one hardware processor and a non-transitory computer-readable medium storing instructions that, when executed by the at least one hardware processor, cause the at least one hardware processor to perform operations comprising: in response to the first calibration object being present in front of the camera such that the camera is facing the first flat surface: activating one or more light sources of the plurality of independently controllable light sources based on a lighting configuration to direct light onto the first flat surface; using the camera to capture one or more images of one or more reflections of the light on the first flat surface; determining if more turns of the first calibration object should be performed; in response to a determination that more turns of the first calibration object should be performed, repeating the activating, using, and determining after turning the first calibration object about the z-axis so that an orientation of the first calibration object changes to a new orientation, until it is determined that no more turns should be performed; using reflections in captured images to determine a distance between the lighting apparatus and the camera; and calibrating the system based on the distance between the lighting apparatus and the camera.

In Example 2, the subject matter of Example 1 includes, wherein the operations further comprise: using the reflections in the captured images to calibrate the camera.

In Example 3, the subject matter of Examples 1-2 includes, wherein the turning comprises turning the first calibration object approximately ninety degrees about the z-axis.

In Example 4, the subject matter of Example 3 includes, wherein it is determined that no more turns of the first calibration object should be performed if the first calibration object has been turned three times.

In Example 5, the subject matter of Examples 1-4 includes, wherein the operations further comprise: prior to determining if more turns of the first calibration object should be performed: determining if there are any more lighting configurations; and, in response to a determination that there are more lighting configurations, repeating the activating and using with another lighting configuration repeatedly until there are no more lighting configurations.

In Example 6, the subject matter of Examples 1-5 includes, wherein the first flat surface is constructed of opal glass.

In Example 7, the subject matter of Example 6 includes, wherein the first flat surface includes a checkboard pattern.

In Example 8, the subject matter of Examples 1-7 includes, wherein the system further comprises a second calibration object comprising a third flat surface at an incline of a second angle from a fourth flat surface, the third flat surface being reflective, the fourth flat surface being perpendicular to a z-axis of the first calibration object; and wherein the operations further comprise: in response to the second calibration object being present in front of the camera such that the camera is facing the third flat surface: activating one or more light sources of the plurality of independently controllable light sources based on a lighting configuration to direct light onto the third flat surface; using the camera to capture one or more images of one or more reflections of the light on the third flat surface; determining if more turns of the second calibration object should be performed; and, in response to a determination that more turns of the second calibration object should be performed, repeating the activating, using, and determining for the second calibration object after turning the second calibration object about the z-axis, so that an orientation of the second calibration object changes to a new orientation until it is determined that no more turns of the second calibration object should be performed.

In Example 9, the subject matter of Example 8 includes, wherein the system further comprises a third calibration object comprising a fifth flat surface, the fifth flat surface being reflective; and wherein the operations comprise: in response to the third calibration object being present in front of the camera such that the camera is facing the fifth flat surface: activating one or more light sources of the plurality of independently controllable light sources based on a lighting configuration to direct light onto the fifth flat surface; and using the camera to capture one or more images of one or more reflections of the light on the fifth flat surface.

Example 10 is a method comprising: in response to a first calibration object being present in front of a camera such that the camera is facing a first flat surface of the first calibration object, the first flat surface at an incline of a first angle from a second surface, the first flat surface being reflective, the second surface being perpendicular to a z-axis of the first calibration object; activating one or more light sources of a plurality of independently controllable light sources of a lighting apparatus based on a lighting configuration to direct light onto the first flat surface; using the camera to capture one or more images of one or more reflections of the light on the first flat surface; determining if more turns of the first calibration object should be performed; in response to a determination that more turns of the first calibration object should be performed, repeating the activating, using, and determining after turning the first calibration object about the z-axis so that an orientation of the first calibration object changes to a new orientation, until it is determined that no more turns should be performed; using reflections in captured images to determine a distance between the lighting apparatus and the camera; and, calibrating a system based on the distance between the lighting apparatus and the camera.

In Example 11, the subject matter of Example 10 includes using the reflections in the captured images to calibrate the camera.

In Example 12, the subject matter of Examples 10-11 includes, wherein the turning comprises, turning the first calibration object approximately ninety degrees about the z-axis.

In Example 13, the subject matter of Example 12 includes, wherein it is determined that no more turns of the first calibration object should be performed if the first calibration object has been turned three times.

In Example 14, the subject matter of Examples 10-13 includes, prior to determining if more turns of the first calibration object should be performed: determining if there are any more lighting configurations; and, in response to a determination that there are more lighting configurations, repeating the activating and using with another lighting configuration repeatedly until there are no more lighting configurations.

In Example 15, the subject matter of Examples 10-14 includes, wherein the first flat surface is constructed of opal glass.

In Example 16, the subject matter of Example 15 includes, wherein the first flat surface includes a checkboard pattern.

In Example 17, the subject matter of Examples 10-16 includes, in response to a second calibration object being present in front of the camera, such that the camera is facing a third flat surface of the second calibration object, the third flat surface at an incline of a second angle from a fourth flat surface, the third flat surface being reflective, the fourth flat surface being perpendicular to a z-axis of the first calibration object: activating one or more light sources of the plurality of independently controllable light sources based on a lighting configuration to direct light onto the third flat surface; using the camera to capture one or more images of one or more reflections of the light on the third flat surface; determining if more turns of the second calibration object should be performed; and in response to a determination that more turns of the second calibration object should be performed, repeating the activating, using, and determining for the second calibration object after turning the second calibration object about the z-axis so that an orientation of the second calibration object changes to a new orientation, until it is determined that no more turns of the second calibration object should be performed.

In Example 18, the subject matter of Example 17 includes, wherein the system further comprises: a third calibration object comprising a fifth flat surface, the fifth flat surface being reflective; in response to a third calibration object comprising: a third calibration object comprising: a fifth flat surface, the fifth flat surface being reflective; being present in front of the camera, such that the camera is facing the fifth flat surface; activating one or more light sources of the plurality of independently controllable light sources based on a lighting configuration to direct light onto the fifth flat surface; and, using the camera to capture one or more images of one or more reflections of the light on the fifth flat surface.

Example 19 is a non-transitory machine-readable storage medium having embodied thereon instructions executable by one or more machines to perform operations comprising: in response to a first calibration object being present in front of a camera such that the camera is facing a first flat surface of the first calibration object, the first flat surface at an incline of a first angle from a second surface, the first flat surface being reflective, the second surface being perpendicular to a z-axis of the first calibration object; activating one or more light sources of a plurality of independently controllable light sources of a lighting apparatus based on a lighting configuration to direct light onto the first flat surface; using the camera to capture one or more images of one or more reflections of the light on the first flat surface; determining if more turns of the first calibration object should be performed; in response to a determination that more turns of the first calibration object should be performed; repeating the activating, using, and determining after turning the first calibration object about the z-axis so that an orientation of the first calibration object changes to a new orientation, until it is determined that no more turns should be performed; using reflections in captured images to determine a distance between the lighting apparatus and the camera; and, calibrating a system based on the distance between the lighting apparatus and the camera.

In Example 20, the subject matter of Example 19 includes, wherein the operations further comprise: using the reflections in the captured images to calibrate the camera.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

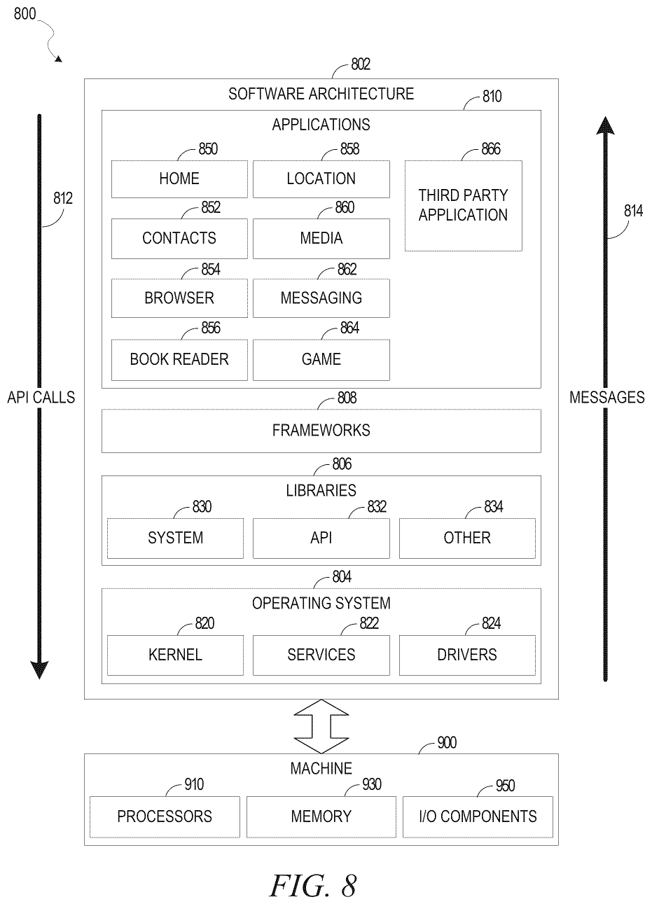

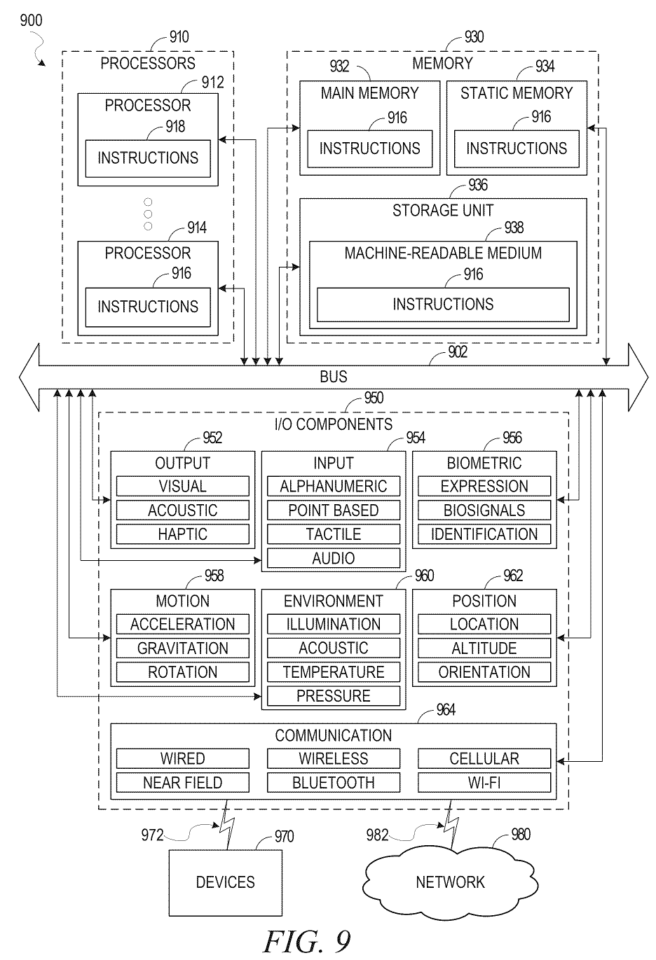

FIG. 8 is a block diagram 800 illustrating a software architecture 802, which can be installed on any one or more of the devices described above. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke Application Program Interface (API) calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionalities. The services 822 can provide other common services for the other software layers. The drivers 824 are responsible for controlling or interfacing with the underlying hardware. For instance, the drivers 824 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two-dimensional [2D] and three-dimensional [3D] in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810. For example, the frameworks 808 provide various graphical user interface functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. The applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine 900 to perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) cause the machine 900 to perform any one or more of the methodologies discussed herein to be executed. For example, the instructions 916 may cause the machine 900 to execute the method 600 of FIG. 6. Additionally, or alternatively, the instructions 916 may implement FIGS. 1-6 and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a CPU, a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor 912), multiple processors 912, 914 with a single core, multiple processors 912, 914 with multiple cores, or any combination thereof.

The memory 930 may include a main memory 932, a static memory 934, and a storage unit 936, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., coupled via a USB).

Moreover, the communication components 964 may detect identifiers or include components operable to detect identifiers. For example, the communication components 964 may include radio-frequency identification (RFID) tag reader components, NFC smart tag detection components, optical reader components (e.g., an optical sensor to detect one-dimensional bar codes such as Universal Product Code [UPC] bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (e.g., 930, 932, 934, and/or memory of the processors 910) and/or the storage unit 936 may store one or more sets of instructions 916 and data structures (e.g., software) embodying or utilized by any one or more of the methodologies or functions described herein. These instructions (e.g., the instructions 916), when executed by the processors 910, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 9G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., Hypertext Transfer Protocol [HTTP]). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a lighting arrangement including one or more independently controllable light source;
a camera;
a first calibration object comprising a first flat surface at an incline of a first angle from a second surface, the first flat surface being reflective, the second surface being perpendicular to a z-axis of the first calibration object; and
a computer system comprising at least one hardware processor and a non-transitory computer-readable medium storing instructions that, when executed by the at least one hardware processor, cause the at least one hardware processor to perform operations comprising:
in response to the first calibration object being present in a field of view of the camera:
activating one or more light source of the one or more independently controllable light source to direct light onto the first flat surface;
activating the camera to capture one or more images of one or more reflections of the light on the first flat surface;
determining if more turns of the first calibration object should be performed;
in response to a determination that more turns of the first calibration object should be performed, repeating the activating, using, and determining after turning the first calibration object about the z-axis so that an orientation of the first calibration object changes to a different orientation, until it is determined that no more turns should be performed;
using reflections in captured images to determine a distance between the lighting arrangement and the camera; and
calibrating the system based on the distance between the lighting apparatus and the camera.

2. The system of claim 1, wherein the operations further comprise using the reflections in the captured images to calibrate the camera.

3. The system of claim 1, wherein the turning comprises turning the first calibration object approximately ninety degrees about the z-axis.

4. The system of claim 3, wherein it is determined that no more turns of the first calibration object should be performed if the first calibration object has been turned three times.

5. The system of claim 1, wherein the operations further comprise:
prior to determining if more turns of the first calibration object should be performed:
determining if there are any more lighting configurations; and
in response to a determination that there are more lighting configurations, repeating the activating and using with another lighting configuration repeatedly until there are no more lighting configurations.

6. The system of claim 1, wherein the first flat surface is constructed of opal glass.

7. The system of claim 6, wherein the first flat surface includes a checkboard pattern.

8. The system of claim 1, wherein the system further comprises:
a second calibration object comprising a third flat surface at an incline of a second angle from a fourth flat surface, the third flat surface being reflective, the fourth flat surface being perpendicular to a z-axis of the first calibration object wherein the operations further comprise:
in response to the second calibration object being present in front of the camera such that the camera is facing the third flat surface:
activating one or more light source of the one or more independently controllable light source based on a lighting configuration to direct light onto the third flat surface;
using the camera to capture one or more images of one or more reflections of the light on the third flat surface;
determining if more turns of the second calibration object should be performed; and
in response to a determination that more turns of the second calibration object should be performed, repeating the activating, using, and determining, for the second calibration object, after turning the second calibration object about the z-axis so that an orientation of the second calibration object changes to a new orientation, until it is determined that no more turns of the second calibration object should be performed.

9. The system of claim 1, wherein the system further comprises a third calibration object comprising a fifth flat surface, the fifth flat surface being reflective, wherein the operations comprise:
in response to the third calibration object being present in front of the camera such that the camera is facing the fifth flat surface:
activating one or more light sources of the plurality of independently controllable light sources based on a lighting configuration to direct light onto the fifth flat surface; and
using the camera to capture one or more images of one or more reflections of the light on the fifth flat surface.

10. A method comprising:
in response to a first calibration object being present in front of a camera such that the camera is facing a first flat surface of the first calibration object, the first flat surface at an incline of a first angle from a second surface, the first flat surface being reflective, the second surface being perpendicular to a z-axis of the first calibration object:
activating one or more light source of one or more independently controllable light source of a lighting apparatus based on a lighting configuration to direct light onto the first flat surface;
using the camera to capture one or more images of one or more reflections of the light on the first flat surface;
determining if more turns of the first calibration object should be performed;
in response to a determination that more turns of the first calibration object should be performed, repeating the activating, using, and determining after turning the first calibration object about the z-axis so that an orientation of the first calibration object changes to a new orientation, until it is determined that no more turns should be performed;
using reflections in captured images to determine a distance between the lighting apparatus and the camera; and
calibrating a system based on the distance between the lighting apparatus and the camera.

11. The method of claim 10, further comprising using the reflections in the captured images to calibrate the camera.

12. The method of claim 10, wherein the turning comprises turning the first calibration object approximately ninety degrees about the z-axis.

13. The method of claim 12, wherein it is determined that no more turns of the first calibration object should be performed if the first calibration object has been turned three times.

14. The method of claim 10, further comprising:
prior to determining if more turns of the first calibration object should be performed:
determining if there are any more lighting configurations; and
in response to a determination that there are more lighting configurations, repeating the activating and using with another lighting configuration repeatedly until there are no more lighting configurations.

15. The method of claim 10, wherein the first flat surface is constructed of opal glass.

16. The method of claim 15, wherein the first flat surface includes a checkboard pattern.

17. The method of claim 10, further comprising:
in response to a second calibration object being present in front of the camera, such that the camera is facing a third flat surface of the second calibration object, the third flat surface at an incline of a second angle from a fourth flat surface, the third flat surface being reflective, the fourth flat surface being perpendicular to a z-axis of the first calibration object:
activating one or more light source of the one or more independently controllable light source based on a lighting configuration to direct light onto the third flat surface;
using the camera to capture one or more images of one or more reflections of the light on the third flat surface;
determining if more turns of the second calibration object should be performed; and
in response to a determination that more turns of the second calibration object should be performed, repeating the activating, using, and determining, for the second calibration object, after turning the second calibration object about the z-axis so that an orientation of the second calibration object changes to a new orientation, until it is determined that no more turns of the second calibration object should be performed.

18. The method of claim 17, wherein the system further comprises a third calibration object comprising:
a fifth flat surface, the fifth flat surface being reflective;
in response to a third calibration object comprising a third calibration object comprising a fifth flat surface, the fifth flat surface being reflective being present in front of the camera such that the camera is facing the fifth flat surface:
activating one or more light sources of the plurality of independently controllable light sources based on a lighting configuration to direct light onto the fifth flat surface; and
using the camera to capture one or more images of one or more reflections of the light on the fifth flat surface.

19. A non-transitory machine-readable storage medium having embodied thereon instructions executable by one or more machines to perform operations comprising:
in response to a first calibration object being present in front of a camera such that the camera is facing a first flat surface of the first calibration object, the first flat surface at an incline of a first angle from a second surface, the first flat surface being reflective, the second surface being perpendicular to a z-axis of the first calibration object:
activating one or more light source of one or more independently controllable light source of a lighting apparatus based on a lighting configuration to direct light onto the first flat surface;
using the camera to capture one or more images of one or more reflections of the light on the first flat surface;
determining if more turns of the first calibration object should be performed;
in response to a determination that more turns of the first calibration object should be performed, repeating the activating, using, and determining after turning the first calibration object about the z-axis so that an orientation of the first calibration object changes to a new orientation, until it is determined that no more turns should be performed;
using reflections in captured images to determine a distance between the lighting apparatus and the camera; and
calibrating a system based on the distance between the lighting apparatus and the camera.

20. The non-transitory machine-readable storage medium of claim 19, wherein the operations further comprise:
using the reflections in the captured images to calibrate the camera.
